(19) United States
(12) Patent Application Publication
(10) Pub. No.: US 2024/0085239 A1
(43) Pub. Date: Mar. 14, 2024

(54) Intelligent Illumination Intensity Measuring Sensor

(71) Applicant: Saudi Arabian Oil Company, (US)

(72) Inventors: Abdulrahman Mukhtar, Dhahran (SA); Qasem Abdullah Fandem, Qatif (SA); Basem Khoj, Dhahran (SA)

(21) Appl. No.: 17/944,288

(22) Filed: Sep. 14, 2022

(51) Int. Cl. G01J 1/44; G05D 1/02

(52) U.S. Cl. CPC G01J 1/44; G05D 1/0274; G05D 1/0278; G01J 2001/446; G05D 2201/0207

(57) ABSTRACT

A system for measuring illumination intensity comprising a casing configured to hold a ball head; a motor physically connected to the ball head configured to rotate the ball head; the ball head physically encased within the casing configured to rotate a telescoping arm; the telescoping arm extending from the ball head configured to extend from the ball head to an extended length; an illumination sensor physically connected to the telescoping arm, the illumination sensor configured to measure illumination intensity; a data processing unit positioned within the casing, the data processing unit is configured to handle functions selected from the group consisting of GPS programming, 2D and 3D virtual drawing and site schematic information, inspecting and testing plans, data storage, illumination intensity analytics programming, and combinations of the same; and a transmitter positioned on the casing configured to transmit data from the data processing unit to a main control system.

### TECHNICAL FIELD

Disclosed are systems and methods for measuring illumination. Specifically, disclosed are systems and methods for performing field illumination intensity testing.

### BACKGROUND

Illumination testing is conducted in a manual manner where field inspectors work overtime to conduct measurements at night. Field inspects conduct illumination testing using simple lux meters. Then inspectors write result on paper which is prone to human errors as well as possible data manipulation. This method requires an extensive time to complete the full process for all testing points. Additionally, the current method requires attendance of several parties including the client, main contractor, and project management team. It also lacks basic analysis features to proactively predict current and future test results.

### SUMMARY

Disclosed are systems and methods for measuring illumination. Specifically, disclosed are systems and methods for performing field illumination intensity testing.

In a first aspect, a system for measuring illumination intensity is provided. The system includes a casing, the casing configured to hold a ball head, a motor physically connected to the ball head, the motor configured to rotate the ball head, the ball head physically encased within the casing, the ball head configured to rotate a telescoping arm, the telescoping arm extending from the ball head, the telescoping arm configured to extend from the ball head to an extended length, an illumination sensor physically connected to the telescoping arm, the illumination sensor configured to measure illumination intensity, a data processing unit positioned within the casing, the data processing unit is configured to handle functions selected from the group consisting of GPS programming, 2D and 3D virtual drawing and site schematic information, inspecting and testing plans, data storage, illumination intensity analytics programming, and combinations of the same, and a transmitter positioned on the casing, the transmitter configured to transmit data from the data processing unit to a main control system.

In certain aspects, the extended length is between 0.1 meters and 2 meters. In certain aspects, the system further includes solar cells positioned on the casing, where the solar cells provide power for the motor. In certain aspects, the illumination sensor is a high speed and high sensitivity silicon PIN photodiode.

In a second aspect, a system for measuring illumination intensity is provided. The system includes an extendable rotatable sensor, the extendable rotatable sensor positioned on the top of a casing, the extendable sensor configured to measure illumination intensity, a data processing unit positioned within the casing, the data processing unit is configured to handle functions selected from the group consisting of GPS programming, 2D and 3D virtual drawing and site schematic information, inspecting and testing plans, data storage, illumination intensity analytics programming, and combinations of the same, a transmitter positioned on the casing, the transmitter configured to transmit data from the data processing unit to a main control system, high resolution cameras positioned on a front of the casing, the high resolution cameras configured to transmit a live video feed, photovoltaic solar panels positioned on the casing, the photovoltaic solar panels configured to convert solar energy to electric energy, and rotatable wheels positioned on the bottom of the casing, the rotatable wheels configured to maneuver around a site.

In certain aspects, the rotatable wheels are wheels mounted on a continuous track.

In a third aspect, a method of measuring illumination intensity is provided. The method includes the steps of maneuvering a smart illumination sensor into a position. The smart illumination sensor includes an extendable rotatable sensor, the extendable rotatable sensor positioned on the top of a casing, the extendable sensor configured to measure illumination intensity, a data processing unit positioned within the casing, the data processing unit is configured to handle functions selected from the group consisting of GPS programming, 2D and 3D virtual drawing and site schematic information, inspecting and testing plans, data storage, illumination intensity analytics programming, and combinations of the same, a transmitter positioned on the casing, the transmitter configured to transmit data from the data processing unit to a main control system, high resolution cameras positioned on a front of the casing, the high resolution cameras configured to transmit a live video feed, photovoltaic solar panels positioned on the casing, the photovoltaic solar panels configured to convert solar energy to electric energy, and rotatable wheels positioned on the bottom of the casing, the rotatable wheels configured to maneuver around a site. The method further includes the steps of positioning the extendable rotatable sensor, and measuring the illumination intensity of the position of the smart illumination sensor to produce illumination intensity data.

In certain aspects, the method further includes the step of transmitting the illumination intensity data with the transmitter. In certain aspects, the method further includes the steps of extending the photovoltaic solar panels, capturing solar energy with the photovoltaic solar panels, and converting the solar energy to electrical energy. In certain aspects, the method further includes the step of capturing still images with the high resolution cameras.

### BRIEF DESCRIPTION OF THE DRAWINGS

These and other features, aspects, and advantages of the scope will become better understood with regard to the following descriptions, claims, and accompanying drawings. It is to be noted, however, that the drawings illustrate only several embodiments and are therefore not to be considered limiting of the scope as it can admit to other equally effective embodiments.

FIG. 1 is a perspective view of an embodiment of the smart illumination sensor.

FIG. 2 is a perspective view of an embodiment of the smart illumination sensor.

In the accompanying Figures, similar components or features, or both, may have a similar reference label.

### DETAILED DESCRIPTION

While the scope of the apparatus and method will be described with several embodiments, it is understood that one of ordinary skill in the relevant art will appreciate that many examples, variations and alterations to the apparatus and methods described here are within the scope and spirit of the embodiments.

Accordingly, the embodiments described are set forth without any loss of generality, and without imposing limitations, on the embodiments. Those of skill in the art understand that the scope includes all possible combinations and uses of particular features described in the specification.

The systems and methods autonomously perform field illumination intensity testing and can transmit the measurements to central control through cloud network functionality. monitoring of fin fan tubes with the use of a smart plug.

Advantageously, the systems and processes eliminate the need for manual measurements with a lux meter and recordation on paper.

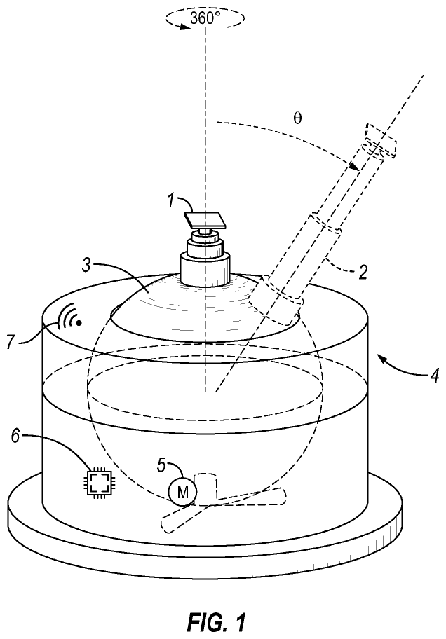

Referring to FIG. 1, a perspective view of an embodiment of the smart illumination sensor is provided. The smart illumination sensor of FIG. 1 can autonomously perform field illumination intensity testing in open or closed areas. The smart illumination sensor of FIG. 1 includes illumination sensor 1. Illumination sensor 1 can be any type of photosensor capable of measuring illumination intensity. In at least one embodiment, illumination sensor 1 can include a high speed and high sensitivity silicon PIN photodiode. A high speed and highly sensitivity silicon PIN photodiode is sensitive to visible and near infrared radiation. The photodiode produces current directly proportional to light intensity. The light intensity (Lux) is measured from the voltage passes across a connected resistance. Illumination sensor is affixed to the end of telescoping arm 2. Telescoping arm 2 can be any type of extendable arm that can operated electronically and controlled remotely. Telescoping arm 2 can be manually controlled or programmed to extend and retract. Telescoping arm 2 can be hydraulically operated or mechanically operated. Telescoping arm 2 can be extendable between 0.1 m and 2 meters. Telescoping arm 2 extends from ball head 3.

Ball head 3 enables illumination sensor 1 and telescoping arm 2 to rotate 360° around a y axis extending from the center of the smart illumination sensor. Additionally, ball head 3 telescoping arm 2 to move off center by angle θ, such that telescoping arm 2 is θ from 0°. The maximum distance of θ is determined by casing 4. Casing 4 surrounds and holds ball head 3 and protects motor 5. Casing 4 can have solar cells installed on the exterior s a source of power for motor 5 and other electronics in the smart illumination sensor. The solar cells can be any type of solar cells capable of running a small object, including solar film.

Motor 5 can be any type of motor capable of operating ball head 3 along a horizontal and vertical axis and around 360° of rotation. Motor 5 can be powered by the solar cells or be operated by batteries or can be operated by batters that are charged by the solar cells.

The embodiment of smart illumination sensor in FIG. 1 is stationery and telescoping arm 2, ball head 3, and motor 5 enable illumination sensor 1 to measure illumination intensity at any angle relative to the central axis of the smart illumination sensor without the need for human intervention. Telescoping arm 2 allows illumination intensity measurements to be taken at different levels.

Also contained within casing 4 can be data processing unit 6. Data processing unit 6 can be any type of processing unit capable of handling computing functions. The functions handled by data processing unit 6 can include GPS programming, 2D and 3D virtual drawing and site schematic information, inspecting and testing plans, data storage, illumination intensity analytics programming, and combinations of the same. Data processing unit 6 can perform the following functions detect anomalies in illumination intensity testing results and send alarms to the main control system, accept or reject illumination intensity test results, provide the results of illumination intensity measurements in a continuous data stream, predict possible future failures and non-conformities based on illumination intensity testing, predict luminaire replacement plan, reflects illumination intensity test result on 3D virtual drawings, capture still and moving pictures of failed testing locations, fetch geographical GPS coordinates, and combinations of the same. Performing the function of accepting or rejecting the illumination intensity test results can be done by validating the test results against predefined criteria. Data processing unit 6 has machine learning capabilities to enable process automation and validation of test results. Data processing unit 6 can send

The smart illumination sensor can include transmitter 7. Transmitter 7 can send and receive data. Transmitter 7 can be any type of wireless transmitter capable of electronically communicating data between the smart illumination sensor and network points, between the smart illumination sensor and other sensors, or between the smart illumination sensor and a main control system. Transmitter 7 enables transmitting the data collected, including the illumination intensity results, to a main control system for permanent data storage.

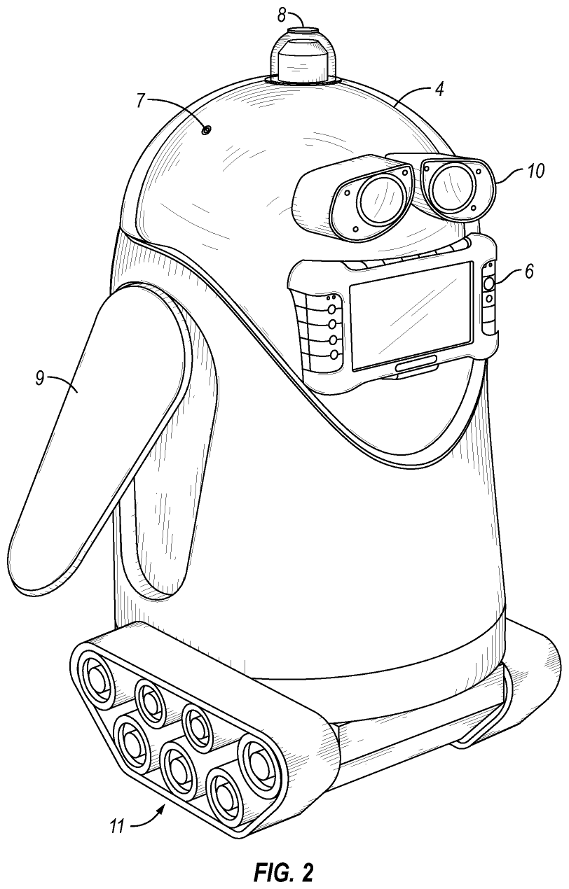

Referring to FIG. 2, an embodiment of the smart illumination sensor is provided. The smart illumination sensor shown in FIG. 2 is a smart illumination robot. The smart illumination robot is mobile such that the smart illumination robot can move around a site taking illumination intensity measurements from different locations or positions. The smart illumination robot shown in FIG. 2 contains casing 4 and data processing unit 6 as described with reference to FIG. 1. The smart illumination robot contains extendable rotatable sensor 8. Extendable rotatable sensor 8 can contain a photosensitive sensor mounted on an extendable arm that can rotate 360° around a central axis. In at least one embodiment, extendable rotatable sensor 8 can be mounted on a guide rail on the back of casing 4 of the smart illumination robot. The guide rail is capable of moving up and down along the entire of height of the smart illumination robot allowing illumination intensity measurements to be taken at ground level. In at least one embodiment, extendable rotatable sensor 8 can be located on the top of smart illumination robot. Being located on top of the smart illumination robot allows extendable rotatable sensor 8 to rotate 360°. Alternately, extendable rotatable sensor 8 is mounted on a guide rail on the back of the smart illumination robot. Extendable rotatable sensor 8 can move vertically up and down the guide rail taking illumination intensity measurements at different elevations. The guide rail allows extendable rotatable sensor 8 to take illumination intensity measurements at ground levels. Extendable rotatable sensor 8 can include two sensors one at a lower elevation than the other. Extendable rotatable sensor 8 can be the same type of sensor as illumination sensor 1.

The smart illumination robot can include data processing unit 6 as described with reference to FIG. 1. Data processing unit 6 can be exterior mounted on the smart illumination robot.

The smart illumination robot can include auxiliary systems to support the functionality for illumination sensitivity testing. Auxiliary systems include photovoltaic solar panels 9, high resolution cameras 10, and rotatable wheels 11.

Photovoltaic solar panels 9 can be any type of photovoltaic solar cell capable of collecting solar energy and turning it into electrical energy. Photovoltaic solar panels 9 can be foldable such that they can extend from the body of the smart illumination robot. Photovoltaic solar panels 9 can be hydraulically extended, mechanically extended, or electronically extended. In at least one embodiment, photovoltaic solar panels 9 can be hydraulically extended. Photovoltaic solar panels 9 provide an independent power source for the built-in batteries on the smart illumination robot. In at least one embodiment, the built-in batteries charged by photovoltaic solar panels 9 provide an independent power source for the electronics on the smart illumination robot along with the power to move rotatable wheels 11 of the smart illumination robot. The smart illumination robot can also include a charging port (not shown) to charge the built-in batteries. In at least one embodiment, photovoltaic solar panels 9 are extended and converting solar energy to electrical energy only while the smart illumination robot is idle.

High resolution cameras 10 can be any type of cameras capable of transmitting a live video feed and capturing video and still images. High resolution cameras 10 can be used to capture live video feeds as the smart illumination robot moves around the site. High resolution cameras 10 can be used to capture video and still images of the locations where illumination intensity measurements are taken. High resolution cameras 10 are front facing cameras.

Rotatable wheels 11 can be any type of wheels or wheels configuration capable of operating over uneven terrain while allowing the smart illumination robot to move in a complete circle (360° range of motion). In at least one embodiment, rotatable wheels 11 are wheels mounted on a continuous track connected to the smart illumination robot. In at least one embodiment, rotatable wheels 11 are wheels mounted on a continuous track that can move forward and backward allowing the smart illumination robot to mover in any direction. In at least one embodiment, rotatable wheels 11 are wheels mounted on a continuous track that can move forward and backward where the track is connected to a base that can rotate 360°. Advantageously, rotatable wheels 11 can allow the smart illumination robot to maneuver around various industrial plant surface geometries and topographies.

Although the present invention has been described in detail, it should be understood that various changes, substitutions, and alterations can be made hereupon without departing from the principle and scope of the invention. Accordingly, the scope of the present invention should be determined by the following claims and their appropriate legal equivalents.

There various elements described can be used in combination with all other elements described here unless otherwise indicated.

The singular forms “a”, “an” and “the” include plural referents, unless the context clearly dictates otherwise.

Optional or optionally means that the subsequently described event or circumstances may or may not occur. The description includes instances where the event or circumstance occurs and instances where it does not occur.

Ranges may be expressed here as from about one particular value to about another particular value and are inclusive unless otherwise indicated. When such a range is expressed, it is to be understood that another embodiment is from the one particular value to the other particular value, along with all combinations within said range.

Throughout this application, where patents or publications are referenced, the disclosures of these references in their entireties are intended to be incorporated by reference into this application, in order to more fully describe the state of the art to which the invention pertains, except when these references contradict the statements made here.

As used here and in the appended claims, the words “comprise,” “has,” and “include” and all grammatical variations thereof are each intended to have an open, non-limiting meaning that does not exclude additional elements or steps.

1. A system for measuring illumination intensity, the system comprising:
a casing, the casing configured to hold a ball head;
a motor physically connected to the ball head, the motor configured to rotate the ball head;
the ball head physically encased within the casing, the ball head configured to rotate a telescoping arm and to move the telescoping arm off center by angle θ, such that the telescoping arm is θ from a y axis extending vertically from the center of the smart illumination sensor;
the telescoping arm extending from the ball head, the telescoping arm configured to extend from the ball head to an extended length;
an illumination sensor physically affixed to the end of the telescoping arm, the illumination sensor configured to measure illumination intensity, wherein the illumination sensor is a high speed and high sensitivity silicon PIN photodiode;
a data processing unit positioned within the casing, the data processing unit is configured to handle functions selected from the group consisting of GPS programming, 2D and 3D virtual drawing and site schematic information, inspecting and testing plans, data storage, illumination intensity analytics programming, and combinations of the same; and
a transmitter positioned on the casing, the transmitter configured to transmit data from the data processing unit to a main control system.

2. The system of claim 1, where the extended length is between 0.1 meters and 2 meters.

3. The system of claim 1, further comprising solar cells positioned on the casing, where the solar cells provide power for the motor.

4. A system for measuring illumination intensity, the system comprising:
an extendable rotatable sensor, the extendable rotatable sensor positioned on the top of a casing, the extendable sensor configured to measure illumination intensity, where the extendable rotatable sensor is a high speed and high sensitivity silicon PIN photodiode;
a data processing unit positioned within the casing, the data processing unit is configured to handle functions selected from the group consisting of GPS programming, 2D and 3D virtual drawing and site schematic information, inspecting and testing plans, data storage, illumination intensity analytics programming, and combinations of the same;
a transmitter positioned on the casing, the transmitter configured to transmit data from the data processing unit to a main control system;
high resolution cameras positioned on a front of the casing, the high resolution cameras configured to transmit a live video feed;
photovoltaic solar panels positioned on the casing, the photovoltaic solar panels configured to convert solar energy to electric energy; and
rotatable wheels positioned on the bottom of the casing, the rotatable wheels configured to maneuver around a site.

5. The system of claim 4, where the rotatable wheels are wheels mounted on a continuous track.

6. (canceled)

7. A method of measuring illumination intensity, the method comprising the steps of:
maneuvering a smart illumination sensor into a position, wherein the smart illumination sensor comprises:
an extendable rotatable sensor, the extendable rotatable sensor positioned on the top of a casing, the extendable sensor configured to measure illumination intensity, where the extendable rotatable sensor is a high speed and high sensitivity silicon PIN photodiode;
a data processing unit positioned within the casing, the data processing unit is configured to handle functions selected from the group consisting of GPS programming, 2D and 3D virtual drawing and site schematic information, inspecting and testing plans, data storage, illumination intensity analytics programming, and combinations of the same;
a transmitter positioned on the casing, the transmitter configured to transmit data from the data processing unit to a main control system;
high resolution cameras positioned on a front of the casing, the high resolution cameras configured to transmit a live video feed;
photovoltaic solar panels positioned on the casing, the photovoltaic solar panels configured to convert solar energy to electric energy; and
rotatable wheels positioned on the bottom of the casing, the rotatable wheels configured to maneuver around a site;
positioning the extendable rotatable sensor; and
measuring the illumination intensity of the position of the smart illumination sensor to produce illumination intensity data.

8. The method of claim 7, further comprising the step of transmitting the illumination intensity data with the transmitter.

9. The method of claim 7, further comprising the steps of extending the photovoltaic solar panels; capturing solar energy with the photovoltaic solar panels; and converting the solar energy to electrical energy.

10. The method of claim 7, further comprising the step of capturing still images with the high resolution cameras.

11. The method of claim 7, further comprising the step of comparing the illumination intensity data to predefined data points; and making a determination to accept the data based on the comparison.
